(19) United States
(12) Patent Application Publication
(10) Pub. No.: US 2026/0297399 A1
(43) Pub. Date: Oct. 1, 2026

(54) INJECTABLE RAPID-CURE TWO-PART COMPOSITION

(71) Applicant: Zephyros, Inc., Romeo, MI (US)

(72) Inventors: Ira MILLER, Romeo, MI (US); Ethan POST, Romeo, MI (US); Michael CZAPLICKI, Romeo, MI (US)

(21) Appl. No.: 19/477,958

(22) PCT Filed: Apr. 23, 2024
(86) PCT No.: PCT/US2024/025765

§ 371 Date: Oct. 23, 2025

Related U.S. Application Data
(60) Provisional application No. 63/461,759, filed on Apr. 25, 2023.

(51) Int. Cl. C09J 11/06; C09J 11/04; C09J 163/04

(52) U.S. Cl. CPC C09J 11/06; C09J 11/04; C09J 163/04

(57) ABSTRACT

The present teachings generally relate to a two-part adhesive and a method for injecting the same. The two-part adhesive comprises a first part and a second part. The first part includes one or more epoxy resins and/or epoxy-functionalized resins. Tire second part includes one or more acidic phosphorous-containing compounds including mineral acid and/or one or more acidic phosphate esters. Preferably, the first and second parts each have a viscosity of about 30,000 cP or less at 25° C. and a shear rate of 10 l/sec such that, after mixing the first and second parts fonning a mixed adhesive, the mixed adhesive can be injected into a bond line defined by a dimension between two surfaces to be adhered by the mixed adhesive.

### CROSS-REFERENCE TO RELATED APPLICATIONS

The present application claims priority to U.S. Provisional Application No. 63/461,759, filed on Apr. 25, 2023, incorporated herein by reference in its entirety for all purposes.

### FIELD

The present teachings generally relate to an injectable rapid-cure two-part composition for forming an adhesive. The two-part composition may be advantageous for injection into narrow bond lines having a dimension of about 3 mm or less.

### BACKGROUND

Manufacturing utilizes many forms of fastening that develop nearly instantaneous joining strength to produce consolidated structures. These include various forms of welding and riveting. As more modern and complex structures are developed to achieve stronger, stiffer, and more lightweight consolidated structures, particularly in automobiles, a wider variety of metals, polymers, and composites are being explored. Joining unique combinations of these metals, polymers, and composites provide challenges in bonding that are not realized by traditional fastening.

Adhesives can be used to improve the manufacturing and assembly process of a structure over traditional means of assembly such as welding and riveting, where localized high stress areas are formed in the system, and in the case of welding or brazing, where the high temperatures may cause warping of the structure. Assembly adhesives are increasingly used due to the need to have multi-material bonding capability, including composites and engineering thermoplastics, but there remains challenges with the adhesives.

Some adhesives react too slowly and do not develop sufficient handling strength or fixture strength rapidly. In this regard, cycle times are limited by the curing time of the adhesive. Other adhesives may react at rates that do not provide sufficient assembly time. In this regard, parts must be rapidly moved into position after application of the adhesive, before the adhesive fully cures.

In the application of the latter, rapid-cure adhesives, pre-assembly of parts can address the challenge of rapidly positioning parts after application of the adhesive. In this regard, there can be a provision of injection points and bond lines between the pre-assembled parts. However, where prior methods of dispensing adhesive provide easily accessible surfaces for adhesive deposition, pre-assembly creates bond lines that are narrow, have one or at most a few injection points for receiving adhesive, have areas distanced from said injection points, and are potentially configured in tortuous paths.

While increasing cure times, injection pressures, and the time during which injection is performed may allow adhesives to travel further from an injection point, doing so would again increase cycle times and moot the solution of pre-assembly, while possibly still not permeating the entirety of the bond lines. Decreasing the viscosity of the adhesive may provide a solution to the aforementioned challenges.

There remains a need in the adhesives industry for adhesives that are simple to formulate (i.e., requiring comparatively fewer ingredients than conventional adhesives), incorporate low-cost ingredients, provide for suitable bonding properties such as lap shear strength and peel resistance, and have cure times that are sufficiently rapid. In this regard, epoxy-based adhesives can find advantages, with acidic phosphorous-containing compounds as curatives.

Acidic phosphorous-containing compounds are capable of performing oxirane ring-opening reactions with oxirane-containing compounds, as taught in U.S. Pat. Nos. 5,648,401 and 10,550,220, incorporated herein by reference in their entireties for all purposes. These patent publications describe the formation of foamed structural reinforcements and baffles. However, they fail to address adhesives for structural assemblies by bonding together two or more parts, non-foaming applications regarding the same, providing the materials with sufficient viscosities to be injectable into narrow and/or tortuous bond lines, and rapid curing of the same.

There is a need for a two-part composition that rapidly cures in about 10 minutes or less, 8 minutes or less, 6 minutes or less, 4 minutes or less, or even 2 minutes or less.

There is a need for a two-part composition that has a sufficiently low viscosity to be injectable within pre-assembled parts, in narrow bond lines that have a dimension of about 3 mm or less, 2 mm or less, or even 1 mm or less.

There is a need for a two-part composition that cures at a temperature below 50° C. (e.g., ambient temperature), such that an additional step of applying a stimulus (e.g., heat, moisture, light, and the like) can be eliminated.

There is a need for a two-part composition that is epoxy-based and is curable without the addition of conventional curatives (e.g., amine-based curatives).

There is a need for a two-part composition that is capable of foaming without the addition of conventional physical and/or chemical blowing agents.

There is a need for a two-part composition that exhibits durable adhesion characterized by shear and peel resistance that is comparatively better than conventional rapid-cure adhesives.

### SUMMARY

The present disclosure relates to a two-part composition, which may address at least some of the needs identified above, the two-part composition comprising a first part including one or more epoxy resins and/or epoxy-functionalized resins; and a second part including one or more acidic phosphorous-containing compounds including mineral acid and/or one or more acidic phosphate esters. Preferably, the first and second parts may each have a viscosity of about 30,000 cP or less at 25° C. and a shear rate of 10 l/sec (as measured by ASTM D2556-14) such that, after mixing the first and second parts a mixture is formed that is injectable into a bond line defined by a dimension between two surfaces to be adhered by the mixture. The first and/or second parts may have a viscosity of about 20,000 cP or less at 25° C.

The first and/or second parts may have a viscosity of about 10,000 cP or less at 25° C.

The two-part composition may be dispensed at a volumetric ratio of about 5:1 to 1:5 (e.g., 4:1) of the first part to the second part.

The dimension of the bond line may be about 2 mm or less, or more preferably about 1 mm or less.

The mixture may migrate from an injection port, within the dimension of the bond line, a distance of about 50 mm to 100 mm, more preferably about 60 mm to 100 mm, more preferably about 70 mm to 100 mm, more preferably about 80 mm to 100 mm, or even more preferably about 90 mm to 100 mm. The distance may be realized by injection of the two-part composition at ambient temperature (i.e., about 20° C. to 25° C.) and a pressure of about 30 psi, and during a period of about 20 seconds.

The mixture may cure to form a solid cured mass within the bond line. The solid cured mass may have a weight of about 8 g to 14 g, more preferably about 10 g to 14 g, or even more preferably about 12 g to 14 g. The weight may be realized by injection of the two-part composition at ambient temperature (i.e., about 20° C. to 25° C.) and a pressure of about 30 psi, and during a period of about 20 seconds.

The mixture may cure at about 50° C. or less (e.g., ambient temperature (i.e., about 20° C. to 25° C.)).

The mixed composition may cure in about 10 minutes or less, more preferably about 8 minutes or less, more preferably about 6 minutes or less, more preferably about 4 minutes or less, or even more preferably about 2 minutes or less.

The one or more acidic phosphate esters may include a phosphate ester derived from a natural oil, preferably a plant-origin oil, such as one that includes at least one phenolic compound with an aliphatic side chain (e.g., cashew nutshell oil).

The one or more acidic phosphate esters may include a phosphate ester derived from 2-ethylhexyl glycidyl ether.

The one or more acidic phosphate esters may include a phosphate ester derived from phenyl glycidyl ether.

The one or more acidic phosphate esters may include a phosphate ester derived from 1-butanol.

The one or more epoxy resins or epoxy-functionalized resins may include one or more liquid epoxy resins, one or more epoxy phenol novolac resins, one or more aliphatic multifunctional resins, one or more epoxy functional natural oils, one or more silane modified epoxy resins, or any combination thereof.

The one or more liquid epoxy resins may include a reaction product of bisphenol A and epichlorohydrin, a reaction product of bisphenol F and epichlorohydrin, or both; preferably at least the reaction product of bisphenol F and epichlorohydrin.

The one or more aliphatic multifunctional resins may include epoxidized sorbitol.

The one or more epoxy functional natural oils may be derived from linseed oil and/or castor oil.

The two-part composition may further comprise a metal carbonate in the first part. The metal carbonate may generate gas after mixing with the second part by a reaction with the one or more acidic phosphorous-containing compounds. The metal carbonate may include calcium carbonate. The calcium carbonate may be present in an amount of about 3% or less, more preferably about 2% or less, or even more preferably about 1% or less, by weight of the first part.

The one or more epoxy resins and/or epoxy-functionalized resins may have a viscosity, at 25° C., of about 4,000 cP or less, more preferably about 3,000 cP or less, more preferably about 2,000 cP or less, or even more preferably about 1,000 cP or less.

The one or more epoxy resins and/or epoxy-functionalized resins may include: a reaction product of bisphenol F and epichlorohydrin, and one or more epoxy functional natural oils (e.g., epoxidized linseed oil and/or epoxidized castor oil).

The first part may further comprise a filler in an amount of about 3% or less, more preferably about 2% or less, or even more preferably about 1% or less, by weight of the first part. The filler may include silica.

The second part may be a blend of the mineral acid and the one or more acidic phosphate esters.

The first and second parts may be each selected so that the rate of cure, upon being mixed, is sufficiently low that the bond line can be filled but is sufficiently high so that the resulting adhered bond line is cured within a period no greater than 10 minutes.

The present disclosure relates to an assembly comprising the two-part composition according to any one or combination of paragraphs above. The assembly may comprise a first article having a first surface and a second article having a second surface, the first and second surfaces defining the bond line.

The first and second surfaces may be bonded by the two-part composition.

The assembly may comprise the injection port providing access to the bond line.

The assembly may be for a vehicle, such as where the first and second elements are frame elements, body panel elements, or reinforcement elements of an automobile, or any combination thereof.

The present disclosure relates to a method for injecting the two-part composition according to any one or combination of paragraphs above, which may address at least some of the needs identified above. The method may comprise mixing the two-part composition to form a mixture. The mixing may be at a volumetric ratio of about 5:1 to 1:5 (e.g., about 4:1) of a first part to a second part respectively of the two-part composition.

The method may comprise injecting the mixture into a bond line having a dimension of about 1 mm or less, via an injection port. Injection may be at a temperature of about 50° C. or less (e.g., ambient temperature (i.e., about 20° C. to 25° C.)).

The method may comprise curing the mixture at a temperature of about 50° C. or less to form a solid cured mass. The mixture may be fully cured in about 10 minutes or less, more preferably about 8 minutes or less, more preferably about 6 minutes or less, more preferably about 4 minutes or less, or even more preferably about 2 minutes or less.

The dimension of the bond line may be defined between surfaces of two articles to be adhered by the mixture. The two articles may be pre-assembled articles.

The method may comprise causing the mixture to migrate from the injection port, within the dimension of the bond line, a distance of about 50 mm to 100 mm, more preferably about 60 mm to 100 mm, more preferably about 70 mm to 100 mm, more preferably about 80 mm to 100 mm, or even more preferably about 90 mm to 100 mm. The distance may be realized by injection of the two-part composition at a temperature of about 50° C. or less (e.g., ambient temperature (i.e., about 20° C. to 25° C.)) and a pressure of about 30 psi, and during a period of about 20 seconds.

The method may comprise causing a quantity of the mixture to enter the bond line such that the solid cured mass has a weight of about 8 g to 14 g, more preferably about 10 g to 14 g, or even more preferably about 12 g to 14 g. The weight may be realized by injection of the two-part composition at a temperature of about 50° C. or less (e.g., ambient temperature (i.e., about 20° C. to 25° C.)) and a pressure of about 30 psi, and during a period of about 20 seconds.

### BRIEF DESCRIPTIONS OF THE DRAWINGS

FIG. 1 is a graph of shear rate against viscosity according to the examples herein.

FIG. 2A is a plan view of a flow mold assembly for preparing the test samples according to the examples herein.

FIG. 2B is a perspective view of the flow mold assembly for preparing the test samples according to the examples herein.

FIG. 2C is a sectional view of the flow mold assembly for preparing the test samples according to the examples herein.

FIG. 3 illustrates cured test samples according to the examples herein.

FIG. 4 illustrates cured test samples according to the examples herein.

### DETAILED DESCRIPTION

The present teachings provide for an improved two-part composition for forming an adhesive and method for injecting the same.

The two-part composition may be provided with a first part and a second part, whereby curing may be initiated upon and/or after mixing of the first and second parts. The first and second parts may be provided in separate containers (e.g., syringe barrels). The first and second parts may mix after being ejected from the containers. In this regard the containers may be coupled to a mixing device such as a static mixer. The first and second parts may be ejected from the containers by pressurizing the containers (e.g., by actuating or depressing plungers that move axially within the containers). Pressurization may be performed manually by a human or by robotic equipment. The first and second parts may be dispensed from a fixed volumetric ratio or a dual-component cartridge.

The two-part composition may form a mixture after exiting the containers. The mixture may be suitable for injection into narrow bond lines. That is, the mixture may have suitable rheological properties (e.g., viscosity) to enter the bond lines via one or more injection ports, traverse a tortuous path, permeate through one or more branches, fill at least a substantial portion of the bond lines (e.g., 90% or more, more preferably 95% or more, 99% or more, or even more preferably 100%), or any combination thereof. The bond lines may be defined by a dimension of about 3 mm or less, 2 mm or less, or even 1 mm or less. The bond lines may have a continuous length. The bond lines may have one or more branches that extend from the continuous length.

The dimension of the bond line may be defined between at least two surfaces. The surfaces may be defined on different parts that are to be adhered together. The parts may be pre-assembled to form the bond lines. The pre-assembled parts may be held together by one or more jigs, dies (e.g., casting dies), frames, clamps, straps, fasteners, the like, or any combination thereof. After curing of the two-part composition, the one or more jigs, dies, frames, clamps, straps, fasteners, the like, or any combination thereof may be removed or may remain during later stages of assembly. In some aspects, fasteners may be applied to hold together different parts and may remain in and/or on the parts, even in the finished articles that are made available to consumers.

The two-part composition may rapidly cure. That is, the two-part composition may cure in about 10 minutes or less, 8 minutes or less, 6 minutes or less, 4 minutes or less, or even 2 minutes or less. Upon curing in the aforementioned time, the two-part composition may have developed suitable lap shear strength, peel resistance, or both such that the pre-assembled parts can be released from any temporary fastening (e.g., by jigs, dies, frames, clamps, straps, fasteners, the like, or any combination thereof).

The two-part composition may cure at a temperature of 50° C. or less (e.g., an ambient temperature of about 20° C. to about 25° C.). In this regard, an additional step of applying a stimulus (e.g., heat, moisture, light, or the like) to initiate and/or increase the cure rate can be eliminated. Thus, the two-part adhesive may find use in both industrial and commercial applications. In industrial applications, while adhesives requiring stimuli may be conventionally used, the extra cycle time associated with applying a stimulus can be eliminated. In commercial applications, consumers may use the two-part adhesive without the need for specialized equipment (e.g., ovens, UV lights, or the like). Thus, the cost and complexity of using the adhesive of the present teachings is reduced relative to conventional rapid-cure adhesives.

The two-part composition may be epoxy-based. The two-part composition may cure without the use of conventional epoxy curatives such as amine-based curatives. Formulation of the two-part adhesive of the present teachings may be free of one or more added curatives, curing accelerators, or both. In this regard, acidic phosphorous compounds may be employed in the two-part adhesive of the present teachings to provide for addition reactions and optionally cross-linking reactions of oxirane-containing compounds. As discussed herein, the acidic phosphorous compounds may act without any additional curing and/or foaming accelerators and may function, at least in part, as both a curative and a foaming agent.

The present teachings contemplate that curing agents, curing agent accelerators, foaming agents, foaming agent accelerators, or any combination thereof may be employed in the two-part composition with the acidic phosphorous compounds, although not necessarily required.

In some aspects, the two-part composition of the present teachings may be capable of foaming. The two-part composition may volumetrically expand by about 5% or more, 10% or more, 20% or more, 40% or more, 60% or more, 80% or more, or even 100% or more relative to the volume of the green state of the two-part composition. The two-part composition may volumetrically expand by about 200% or less, 180% or less, 160% or less, 140% or less, or even 120% or less relative to the volume of the green state of the two-part composition. Green state, as referred to herein, may mean the combined volume of the first and second parts prior to the initiation of curing and/or foaming, such as the combined volumes of the first and second parts prior to mixing the same or the volume of the mixed first and second parts prior to initiation of curing and/or foaming (e.g., where there is some delay thereof).

The two-part composition may comprise one or more metal oxides, which react with the acidic phosphorous compounds to produce gas and cause the mixture to foam. In this regard, the two-part composition of the present teachings may be free of one or more added foaming agents, foaming agent accelerators, or both. The two-part composition of the present teachings may be advantageous in foaming without relying on additives (e.g., conventional foaming agents and foaming agent accelerators, discussed herein) that may increase the viscosity of the composition.

The two-part composition of the present teachings may provide durable adhesion of two or more parts. By the acidic phosphorous compounds of the present teachings, desirable adhesion may be provided for. Acidic phosphorous compounds may react with a variety of substrates including siliceous, cementitious, metallic, and ceramic materials, forming covalent and/or ionic bonds with the same. In this regard, the acidic phosphorous compounds may function as both a curative and adhesion promoter, and optionally a contributor to a foaming reaction.

The two-part composition may exhibit high lap shear strength, peel resistance, or both. The lap shear strength may be about 8 MPa or more, more preferably about 12 MPa or more, more preferably about 16 MPa or more, more preferably about 20 MPa or more, or even more preferably about 24 MPa or more. The lap shear strength and peel resistance may be dependent on the materials the adhesive adheres, as discussed herein.

The first part (“part A”) may comprise one or more epoxy resins and/or epoxy-functionalized resins. The one or more epoxy resins and/or epoxy-functionalized resins may have a functionality of at least 2. The one or more epoxy resins and/or epoxy-functionalized resins may include those having viscosities that do not negatively impact the injectability of the two-part adhesive.

The epoxy resins and/or epoxy-functionalized resins may include one or more liquid epoxy resins, one or more epoxy phenol novolac resins, one or more aliphatic multifunctional resins, one or more epoxy functional natural oils, one or more silane modified epoxy resins, or any combination thereof.

The one or more liquid epoxy resins may include a reaction product of bisphenol A and epichlorohydrin, a reaction product of bisphenol F and epichlorohydrin, or both.

Preferred liquid epoxy resins may include the reaction products of bisphenol A and epichlorohydrin, and of bisphenol F and epichlorohydrin. More preferably, the reaction product of bisphenol F and epichlorohydrin may be used, which has a lower viscosity (about 3,000 to 5,000 cP at 25° C.) compared to the reaction product of bisphenol A and epichlorohydrin (about 11,000 to 15,000 cP at 25° C.).

Viscosities, as discussed herein, may be determined according to ASTM D445, unless otherwise stated.

The liquid epoxy resins may have an average molecular weight of about 300 atomic mass units (“amu”) or more, 350 amu or more, or even 400 amu or more. The liquid epoxy resins may have an average molecular weight of about 600 amu or less, 550 amu or less, or even 500 amu or less.

The liquid epoxy resins may have an epoxide functionality of about 1.8 to about 2.5.

The reaction product of bisphenol A and epichlorohydrin may have an epoxy equivalent weight of about 175 g/eq to 195 g/eq. Epoxy equivalent weights, as discussed herein, may be determined according to ASTM D-1652, unless otherwise stated.

The reaction product of bisphenol A and epichlorohydrin may have a viscosity of about 11,000 centipoise (“cP”) or more, 11,500 cP or more, 12,000 cP or more, or even 12,500 cP or more. The reaction product of bisphenol A and epichlorohydrin may have a viscosity of about 15,000 cP or less, 14,500 cP or less, 14,000 cP or less, 13,500 cP or less, or even 13,000 cP or less.

The reaction product of bisphenol F and epichlorohydrin may have an epoxy equivalent weight of about 160 g/eq to 180 g/eq.

The reaction product of bisphenol F and epichlorohydrin may have a viscosity, at 25° C., of about 3,000 cP or more, 3,500 cP or more, or even 4,000 cP or more. The reaction product of bisphenol F and epichlorohydrin may have a viscosity, at 25° C., of about 5,500 cP or less, 5,000 cP or less, or even 4,500 cP or less.

Examples of suitable bisphenol A epoxy resins may include EPON™ 825 or 828, commercially available from Westlake Epoxy; EPOKUKDO YD-128, commercially from Kukdo Chemical; DER 331, commercially available from Olin Epoxy; and Epotec® YD 128, commercially available from Aditya Birla Chemical.

Examples of suitable bisphenol F epoxy resins may include EPON™ 862, commercially available from Westlake Epoxy; EPOKUKDO YDF-170, commercially available from Kukdo Chemical; DER 354, commercially available from Olin Epoxy; and Epotec® YDF 172LV, commercially available from Aditya Birla Chemical.

The liquid epoxy resins may be present in an amount of about 20% or more, 30% or more, or even 40% or more, by weight of the first part. The liquid epoxy resins may be present in an amount of about 70% or less, 60% or less, or even 50% or less, by weight of the first part.

The one or more aliphatic multifunctional resins may be derived from the epoxidation of polyols. The polyol may be selected from sugar alcohols. An exemplary aliphatic multifunctional resin may include epoxidized sorbitol. The aliphatic multifunctional resin may have a viscosity, at 25° C., of about 8,000 cP or more, 10,000 cP or more, or even 12,000 cP or more. The aliphatic multifunctional resin may have a viscosity, at 25° C., of about 18,000 cP or less, 16,000 cP or less, or even 14,000 cP or less.

The one or more epoxy functional natural oils may include epoxidized forms of natural oils such as epoxidized cashew nutshell liquid (“ECNSL”), epoxidized linseed oil (“ELO”), epoxidized castor oil (“ECO”), epoxidized vegetable oils, epoxidized soybean oil (“ESO”), epoxidized tall oil, or any combination thereof. The epoxy functional natural oils may be useful due to their very low viscosities. For example, epoxidized linseed oil may have a viscosity of about 750 cP and epoxidized castor oil and epoxidized soybean oil may have viscosities of about 400 cP.

The natural oil may be monounsaturated (e.g., tall oil and CNSL) or polyunsaturated (e.g., linseed oil and soybean oil), where each site of unsaturation, by epoxidation, provides for an epoxy group site. Preferably, the natural oil is polyunsaturated such that epoxies with a functionality of greater than 2 and accordingly cross-linking may be provided for. The present teachings contemplate that a blend of monounsaturated and polyunsaturated natural oils may be employed. While not providing for cross-linking, the monounsaturated natural oils may function as reactive plasticizers.

The epoxy functional natural oils may have an oxirane content of about 7% to about 10% by weight of the first part.

The epoxy functional natural oils may have a viscosity, at 25° C., of about 40 cP or more, 100 cP or more, 200 cP or more, 300 cP or more, 400 cP or more, or even 500 cP or more. The epoxy functional natural oils may have a viscosity, at 25° C., of about 900 cP or less, 800 cP or less, 700 cP or less, or even 600 cP or less.

Examples of preferred epoxy functional natural oils may include Epoxol® 9-5 (ELO) and Epoxol® 7-4 (ESBO), commercially available from ACS Technical Products; and Epiol PE412 (ECO), commercially available from Kukdo Chemical. Other suitable examples include Lankroflex™ L (ELO), commercially available from Valtris Specialty Chemicals; Vikoflex® 7190 (ELO), commercially available from Cargill; Plasthall® ELO (ELO), commercially available from Hallstar; Lankroflex™ E2307 (ESO) and Plas-Chek 775 (ESO), commercially available from Valtris Specialty Chemicals; ChemFlexx Epoxidized Soybean Oil (ESO), commercially available from The Chemical Company; ESBO, commercially available from KH Chemicals; and NC-513 (ECNSL), NC-514 (ECNSL), and NC-547 (ECNSL), commercially available from the Cardolite Company.

The liquid epoxy resins may be present with one or more of the aforementioned epoxy resins and/or epoxy-functionalized resins. The epoxy functional natural oils may be advantageous in their lower viscosities relative to the liquid epoxy resins. The degree of functionality and molecular structure of the liquid epoxy resins and epoxy functional oils and optionally one or more diluents may be utilized to formulate adhesive products with varying mechanical properties including elastic modulus, lap shear strength, and peel resistance, while enabling low viscosity of the first part for injectability.

The epoxidized natural oils may be present in the first part in an amount of about 30% or more, 40% or more, or even 50% or more, by weight of the first part. The epoxidized natural oils may be present in the first part in an amount of about 80% or less, 70% or less, or even 60% or less, by weight of the first part.

The second part (“part B”) may comprise one or more acidic phosphorous-containing compounds. The acidic phosphorous-containing compounds may function to modulate the modulus of the adhesive with varying degrees of rigidity or strain to failure; increased adhesion strength to metals, polymers, and composites; or both.

The acidic phosphorous-containing compounds may include mineral acid, one or more acidic phosphate esters, or both. In some aspects, the second part of the two-part adhesive may comprise a blend of mineral acid with one or more acidic phosphate esters.

The acid strength of the acidic phosphorous-containing compounds, including blends thereof (e.g., a blend of mineral acid with an acidic phosphate ester) may be selected to adjust the rate of curing, the initiation of foaming, the duration of foaming, or any combination thereof.

An exemplary mineral acid may include 85% phosphoric acid, commercially available from Innophos® or Alliance Chemical. Another exemplary mineral acid may include polyphosphoric acid (also known as “115% phosphoric acid”), commercially available from Innophos® and Cameo Chemicals.

Phosphoric acid is trifunctional and is generally very reactive with oxirane rings. Polyphosphoric acid may be employed to increase the pH and scavenge water to adjust reactivity and adhesive properties, respectively.

The mineral acid may be present in an amount of about 5% or more, 10% or more, 20% or more, or even 30% or more, by weight of the second part. The mineral acid may be present in an amount of about 60% or less, 50% or less, or even 40% or less, by weight of the second part.

The acidic phosphate esters may be selected from mono-esters, di-esters, or tri-esters as shown below:

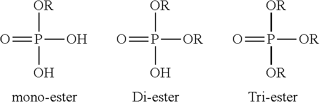

The present teachings contemplate that the composition may comprise tri-esters, as shown above. Although typically not reactive, residues of tri-esters may be present as reaction byproducts in the synthesis of the organic phosphorous compounds or added as a mixture with the mono-esters and/or di-esters.

The organic phosphorous compounds may be obtained from the reaction of epoxide groups with phosphoric acid as depicted below, where R is preferably an aliphatic, cycloaliphatic, or aromatic moiety:

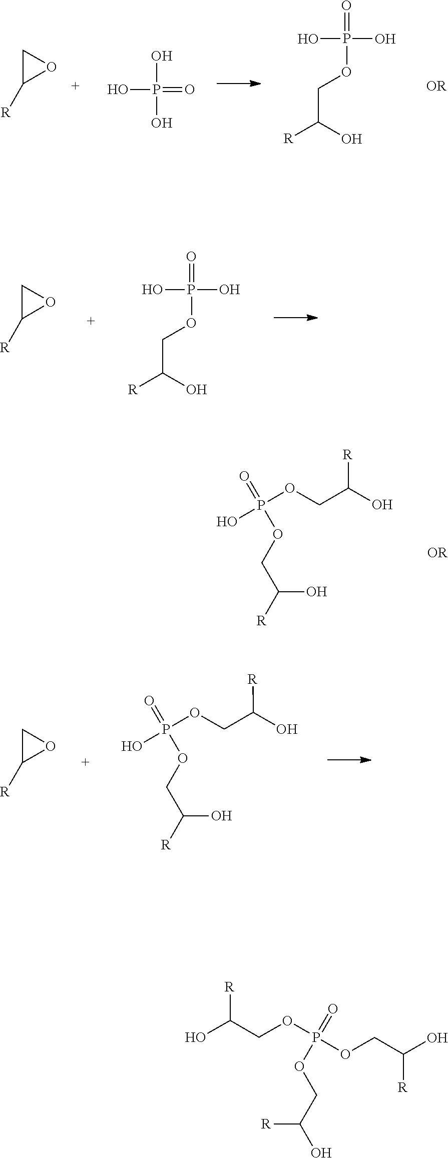

The acidic phosphate esters may be included to modulate the adhesive polymerization rate, molecular functionality, and degree of cross-linking. Mono-esters of phosphoric acid may reduce the functionality of the curing agent and aid in controlling the polymerization and architecture of the polymer network.

Exemplary mono-esters may include reaction products of phosphoric acid and an aliphatic epoxide, reaction products of phosphoric acid and an aromatic epoxide, or both.

Exemplary mono-esters may include Erisys GE-6 (2-ethylhexyl glycidyl ether), commercially available from the Huntsman Corporation or ME102 (2-ethylhexyl glycidyl ether) from Kukdo Chemical; and/or NC-513 (epoxidized cashew nutshell liquid), commercially available from the Cardolite Corporation.

The acidic phosphate ester may be present in an amount of about 5% or more, 10% or more, 20% or more, 40% or more, or even 50% or more, by weight of the second part. The acidic phosphate ester may be present in an amount of about 100% or less, 90% or less, 80% or less, or even 70% or less, by weight of the second part.

The viscosities of the first and second parts may be different by about 20% or more, 40% or more, 60% or more, 80% or more, or even 100% or more. The viscosities of the first and second parts may be different by about 300% or less, 200% or less, 180% or less, 160% or less, 140% or less, or even 120% or less.

The two-part adhesive may comprise one or more additives. The additives may or may not participate in a reaction with other components of the two-part adhesive. The additives may modify the lap shear strength, peel resistance, rheology properties, or any combination thereof.

The additives may include one or more impact modifiers. It is understood that the impact modifiers may be present in the first and/or second parts. The impact modifiers may function to improve the fracture toughness of the polymeric matrix. The impact modifiers may be characterized by having a soft portion of the molecule in which the glass transition temperature is less than at least about −20° C. or even more preferably less than at least about −40° C. The impact modifiers may be liquid or solid at ambient temperature (i.e., about 20° C. to about 25° C.). The impact modifiers may or may not react into the polymeric matrix of the epoxy resins and/or epoxy-functionalized resins. The impact modifiers may be miscible (e.g., liquid butadiene, butadiene acrylonitrile rubbers or blocked polyurethanes) or insoluble (e.g., core-shell impact modifiers, crumb rubbers, or ground tire rubber) in the two-part adhesive.

A preferred example of an impact modifier may include KaneAce® core-shell tougheners from the Kaneka Corporation. Other suitable examples may include Clearstrength®E950, XT-100 or XT-151 from Arkema, Paraloid™ from the Dow Chemical Company, and Albidur® from Evonik Industries.

While advantageous for fracture toughness, the impact modifiers may increase the viscosity of the two-part adhesive. However, where suitably low viscosity constituents of the two-part adhesive are employed (e.g., a reaction product of bisphenol F and epichlorohydrin and optionally one or more epoxidized natural oils), the impact modifiers may be employed.

The impact modifiers may be present in an amount of about 20% or more, 25% or more, or even 30% or more by weight of the first and/or second parts. The impact modifiers may be present in an amount of about 40% or less, or even 35% or less, by weight of the first and/or second parts.

The additives may include one or more foaming agents. The foaming agents may generate gas. The gas may be trapped by the polymer matrix and curing may affix the polymer matrix in the expanded volume. Foaming may improve adhesion and/or counteract shrinkage that may be realized during curing.

Foaming may be achieved by the presence of one or more metal carbonates, blowing agents, or both in the adhesive. Metal carbonates (e.g., calcium carbonate) may be preferred for its reactivity with the acidic phosphorous curatives of the present teachings. It is understood that the metal carbonate may be present in the first part only, due to its reactivity with the acidic phosphorous curative in the second part. The metal carbonate may function to react with the acidic phosphorous-containing compounds to form a gas and cause the two-part adhesive to foam.

The present teachings contemplate that the two-part adhesive may comprise one or more blowing agents, such as physical blowing agents and/or chemical blowing agents. The physical blowing agents and/or chemical blowing agents may be present in the part with the metal carbonates.

Examples of suitable chemical blowing agents may include dinitrosopentamethylenetetrarnine, azodicarbonamide, dinitroso-pentamethylenetetramine, 4,4′oxy-bis-(benzene-sulphonyihydrazide), trihydrazinotriazine, N,N′-dimethyl-N,N′-dinitroso-terephthalamide, or any combination thereof.

Examples of suitable physical blowing agents may include physical blowing agents sold under the tradename Expancel®, commercially available from Akzo Nobel.

Examples of suitable metal carbonates may include the calcium carbonates of Hubercarb® Q2, Q4, Q200 or Q325 from Huber Engineered Materials.

The foaming agent may be present in an amount of about 10% or less, 8% or less, 6% or less, 4% or less, or even 2% or less, by weight. The first part may be free of metal carbonate and thus a non-foaming composition may be realized. Where metal carbonates are employed, they may be present in the first side as they may be reactive with the acidic phosphorous curative in the second side. The blowing agents may be present in the first and/or second sides.

The additives may include dyes and/or pigments. The dyes and/or pigments may be provided for aesthetic reasons, UV blocking, reinforcing, adhesion promotion, or any combination thereof. The dyes and/or pigments may be organic or inorganic. Examples of suitable dyes and/or pigments may include carbon blacks, TiO2, iron oxide-based pigments, zinc oxides, zinc phosphates, phthalocyanine blue, toluidine red, or any combination thereof.

Some dyes and/or pigments may function to impart humidity resistance to the two-part adhesive. In this regard, these dyes and/or pigments may react with moisture to form a metal hydroxide barrier at the metal-adhesive interface. In the case that the adhered substrate comprises metal, corrosion may be inhibited. These may include inorganic pigments such as zinc phosphates, calcium phosphates, barium phosphosilicates, strontium zinc phosphosilicates, or any combination thereof. Examples of suitable dyes and/or pigments may include Halox® SZP-391, Halox® CW-291, and Halox® CW-491, commercially available from ICL Specialty Products Inc.; Nubirox 301 and 302 commercially available from the Ferro Corporation; and Lubrizol® 219, commercially available from the Lubrizol Corporation.

The dyes and/or pigments may be present in an amount of about 10% or less, 8% or less, 6% or less, 4% or less, or even 2% or less by weight of the first and/or second parts.

The additives may include one or more fillers. The fillers may function to control mix ratios, provide reinforcing properties, control rheology, control density, provide dimensional stability and/or impact resistance, or any combination thereof. Preferably the fillers may have a particle size of about 1 mm or less to maintain the injectability of the two-part adhesive. The filler may be in the form of cubic, plate-like, acicular, fiber-like particles, or any combination thereof.

The filler may include wollastonite, clays, talc, ground rubber, core-shell rubber, glass fibers, milled glass, aramid fibers, fumed or precipitated silicas, fly ash, resinous dust, other minerals and micronized waste products, or any combination thereof. A preferred example of filler may include fumed silica under trade names of Aerosil® and Cab-o-sil®, commercially available from Evonik Industries and Cabot Corporation respectively.

The filler may be present in an amount of about 6% or less, 4% or less, 3% or less, 2% or less, or even 1% or less, by weight of the first and/or second parts. The two-part adhesive may be free of a filler.

The additives may include one or more ultraviolet absorbers (“UVA”) or hindered amine light stabilizers (“HALS”). The UVA and HALS may function to improve resistance to photo-oxidation due to long-term exposure to ultraviolet light. The UVA may achieve the same by having strong absorption peaks in the ultraviolet range. The HALS may achieve the same by reacting with photoradicals and converting the same to comparatively less damaging peroxy species. The UVA and/or HALS may be present in the first and/or second parts.

Examples of suitable UVA materials include but are not limited to Poly(oxy-1,2-ethanediyl),.alpha.-[3-[3-(2H-benzotriazol-2-yl)-5-(1,1-dimethylethyl)-4-hydroxyphenyl]-1-oxopropyl]-.omega.-hydroxy, and 2-(2H-Benzotriazol-2-yl)-4,6-ditertpentylphenol.

Examples of suitable HALS include but are not limited to bis(1,2,2,6,6-pentamethyl-4-piperidyl) sebacate, and methyl 1,2,2,6,6-pentamethyl-4-piperidyl sebacate.

The additives may include one or more surfactants. The surfactants may function to impart substrate and/or filler wetting, viscosity reduction, air release, and defoaming. The wetting may improve adhesion of the polymer matrix to the substrate. The surfactants may be present in the first and/or second parts.

The additives may include one or more plasticizers. The plasticizers may function to reduce viscosity, improve strain to failure, reduce stiffness of the cured mass, control mix ratios, or any combination thereof. The plasticizers may be characterized by low molecular weight and may or may not react into the polymeric matrix.

The additives may include chemical reactive agents. The reactive dehydration agents may function to react with water entrained in the first and/or second parts. The reactive dehydration agents may include but are not limited to isocyanates (e.g., p-toluenesulfonyl isocyanate), oxazolidines, silanes (e.g., vinyl trimethoxy silane), organic acid anhydrides (e.g., maleic anhydride), inorganic acid anhydrides (e.g., polyphosphoric acid), phosphorous pentoxide, Group 2 metal oxides (e.g., calcium oxides), or any combination thereof.

The additives may include physical dehydration agents. The physical dehydration agents may function to absorb water from the first and/or second parts into a crystal lattice. The physical dehydration agents may include partially or fully dehydrated crystalline salts. The physical dehydration agents may include anhydrous copper sulfate and calcium sulfate hemihydrate.

An additional method of water entrapment is through the use of highly hydrophilic particles in the first and/or second parts. Such materials adsorb moisture and will not readily release moisture back into the first and/or second parts. Examples of such materials may include, but are not limited to, molecular sieves, silica gel, and sodium polyacrylate.

The additives may include one or more high molecular weight resins. The high molecular weight resins may function to increase compressive modulus, tensile modulus, tensile stress, tensile elongation, environmental exposure resistance and chemical resistance, or any combination thereof. The high molecular weight resins may include, but are not limited to, (meth)acrylate polymers and copolymers, phenoxy resins, urethane resins, polyvinyl alcohols, polyvinyl butyrals, ethylene vinyl acetates, and cellulosic resins.

The two-part adhesive may function to bond two articles. The two articles may be for a vehicle, such as an automobile. Each article may comprise a surface, where the two-part adhesive may bond the surfaces of the two articles.

The articles may include one or more frame elements, body panel elements, reinforcement elements, or any combination thereof. The frame elements may be of a unibody or body-on-frame construction. Exemplary, but non-limiting, frame elements may include pillars, cross-members, bulkheads, floor pans, floor tunnels, sills, pans, beams, wheelhouses, the like or any combination thereof. The body panels may include doors, roof panels, quarter panels, hood panels, cowls, hatch panels, the like, or any combination thereof. The reinforcement elements may be disposed within cavities such as cavities defined within frame elements.

The present application provides for a method of injecting the two-part composition. Injection may be into a bond line. The bond line may be defined by two surfaces of at least two articles as described herein. The articles may be pre-assembled articles. That is, the articles may comprise one or more discrete elements adhered and/or fastened together to form the pre-assembled article.

The method may comprise mixing the two-part composition to form a mixture. The mixing may be at a volumetric ratio of about 5:1 to 1:5 (e.g., about 4:1) of the first part to the second part of the two-part composition.

The method may comprise injecting the mixture into a bond line. The bond line may have a dimension of about 2 mm or less, or even more preferably about 1 mm or less. The two-part composition may be injected into an injection port. Said injection may be at a temperature of about 50° C. or less, more preferably ambient temperature (i.e., about 20° C. to 25° C.).

The method may comprise curing the mixture at a temperature of about 50° C. or less, more preferably ambient temperature (i.e., about 20° C. to 25° C.). The two-part composition may cure to form a solid cured mass. The two-part composition may fully cure in about 10 minutes or less, more preferably about 8 minutes or less, more preferably about 6 minutes or less, more preferably about 4 minutes or less, or even more preferably about 2 minutes or less.

The method may comprise causing the mixture to migrate from the injection port. The mixture may migrate a distance from the injection port of about 50 mm to 100 mm, more preferably about 60 mm to 100 mm, more preferably about 70 mm to 100 mm, more preferably about 80 mm to 100 mm, or even more preferably about 90 mm to 100 mm.

The method may comprise causing a quantity of the mixture to enter the bond line such that the resulting solid cured mass has a weight of about 8 g to 14 g, more preferably about 10 g to 14 g, or even more preferably about 12 g to 14 g.

The following examples provide for two-part adhesive formulations and characterization of the rheology properties of the same. The rheology properties may be relevant to the dispensability/injectability of the two-part adhesive through the barrel, tip, and/or one or more mixers of dispensing assemblies.

Exemplary Formula 1 and Comparison Formulas 2 through 6 were prepared according to Table 1. Amounts are expressed as percent by weight (wt. %). The adhesive is provided as a two-part adhesive with Part A and Part B.

Comparative Formulas 2 through 5 use a silica filler to increase the viscosity of Part A relative to Part 2. Comparative Formula 6 employs a bisphenol A liquid epoxy, having a viscosity of about 12,500 cP at 25° C., compared to the bisphenol F epoxy resin, having a viscosity of about 3,500 cP at 25° C., used in Comparative Formulas 2 through 5.

TABLE 1

| Part A | 1A | 2A | 3A | 4A | 5A | 6A |
|---|---|---|---|---|---|---|
| Bisphenol F liquid epoxy | 25.23 | 25.10 | 24.98 | 24.85 | 24.72 | — |
| Epoxidized linseed oil | 48.50 | 48.26 | 48.00 | 47.76 | 47.52 | 48.50 |
| Core-shell particles | 19.27 | 19.17 | 19.08 | 18.98 | 18.88 | 19.27 |
| (polybutadiene) in | | | | | | |
| bisphenol A liquid epoxy | | | | | | |
| Calcium carbonate | 2.00 | 1.99 | 1.98 | 1.97 | 1.96 | 2.00 |
| Zinc phosphate corrosion | 4.00 | 3.98 | 3.96 | 3.94 | 3.92 | 4.00 |
| inhibitor | | | | | | |
| Silica | 1.00 | 1.50 | 2.00 | 2.50 | 3.00 | 1.00 |
| Bisphenol A liquid epoxy | — | — | — | — | — | 25.23 |
| Part B | 1B | 2B | 3B | 4B | 5B | 6B |
| 85 wt. % Phosphoric acid | 15.00 | 15.00 | 15.00 | 15.00 | 15.00 | 15.00 |
| Phosphate acid ester | 84.90 | 84.90 | 84.90 | 84.90 | 84.90 | 84.90 |
| Pigment | 0.10 | 0.10 | 0.10 | 0.10 | 0.10 | 0.10 |

Rheological properties for each formulation of Table 1 were characterized using full dynamic mechanical analysis (“DMA”) with a conventional shear sweep method. The tests were performed at about 25° C. The formulations (sample volume of 0.75 cm³) were disposed between two 25 mm stainless steel plates, which were then set to a 1.5 mm gap. The shear rate sweep was from 0.1 to 100 s⁻¹ using a steady state criterion for each data point. Testing was conducted based on ASTM D2556-14.

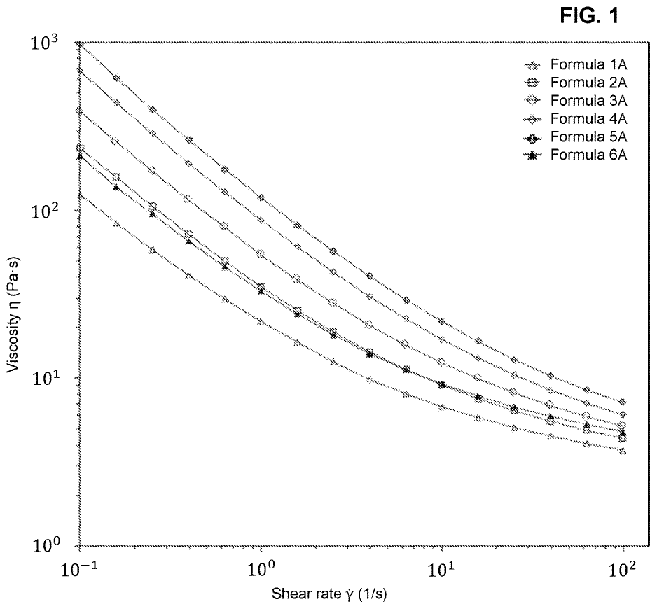

FIG. 1 shows curves generated from the DMA analysis for the Part A formulations with the shear rate (1/s) on the X-axis and the viscosity (Pas) on the Y-axis. The scales of the X and Y axes are logarithmic. The curves produced by each formulation generally proceeds, from lesser viscosity to greater viscosity (at 10² l/s), as Formula 1A, Formula 2A, Formula 6A, Formula 3A, Formula 4A, and Formula 5A. The curves of Formula 2A and Formula 6A cross at about 10¹ l/s.

Table 2 shows quantitative values from the DMA analysis for both of the Part A and Part B samples. The viscosities reported in Table 2 are at 10 l/sec, which was chosen as best representative of the flow in typical static mixing and dispensing/injection operations.

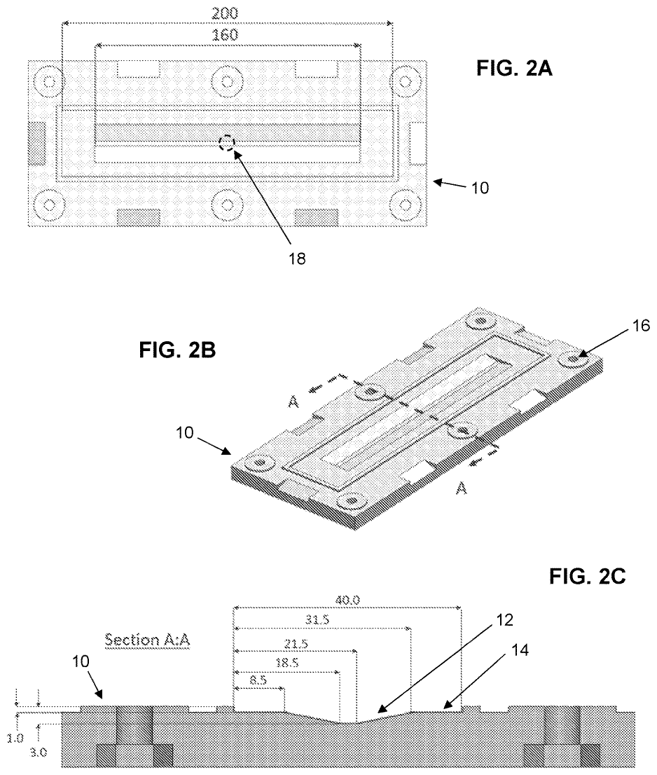

Rheology was also characterized by injecting each formulation upon a flow mold 10, fabricated from 3D printed polylactic acid (PLA), as shown in FIG. 2A through FIG. 2C. The flow mold 10 was constructed with a sloped cavity 12 and a step 14 upon which the formulations were dispensed and flowed upon. The flow mold 10 includes holes 16 for accepting bolts to fasten a transparent, polycarbonate lid (not shown) thereto, where the lid has an injection port 18 in the center thereof. The lid contains the dispensed formulations within the sloped cavity 12 and the step 14 by sealing against the rectangular projection circumscribing the sloped cavity 12 and the step 14.

Dimensions of the flow mold 10 are provided in FIG. 2A and FIG. 2C, where the values are represented in millimeters (“mm”). The center of the flow mold 10 is 4 mm deep, including the 3 mm depth of the sloped cavity 12 and the 1 mm depth the step 14. The total length of the sloped cavity 12 is 160 mm and the total length of the region including the step 14 is 200 mm. The step 14 is 8.5 mm wide on the sides and 20 mm wide on the ends.

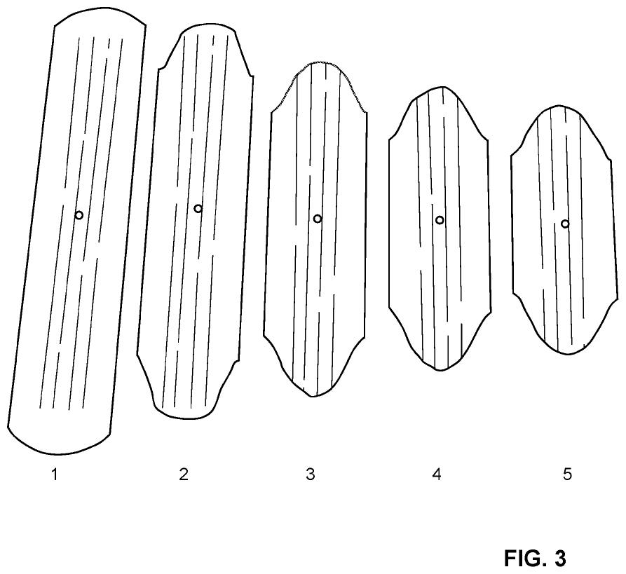

Each sample was injected into the injection port using a Nordson EFD Ultimus™ I unit, with a Sulzer MAQ 05-24L static mixer. Thus, the static mixer provided for the mixing of Part A and Part B. Pressure and time were controlled during dispensing. Each part of formulations were provided in 50-mL cartridges and mixed at a ratio (by volume) of 4:1 of Part A to Part B. After injecting, the formulations were left to cure for about 1 minute. After curing, the cured mass was removed and characterized, as set forth in Table 2. Each of the duly-labelled cured masses are shown in FIG. 3.

Each sample was dispended freely onto a surface for a period of 5 seconds using a Nordson EFD Ultimus™ I unit, with a Sulzer MAQ 05-24L static mixer. Thus, the static mixer provided for the mixing of Part A and Part B. Pressure and time were controlled during dispensing. Each part of formulations were provided in 50-mL cartridges and mixed at a ratio (by volume) of 4:1 of Part A to Part B. After injecting, the formulations were left to cure for about 1 minute. After curing, the cured mass was removed and characterized, as set forth in Table 2.

TABLE 2

| Formula: | 1 | 2 | 3 | 4 | 5 | 6 |
|---|---|---|---|---|---|---|
| Part A viscosity (cP at 10 1/second and 25° C.) | 6,740 | 9,080 | 12,300 | 16,950 | 21,640 | 9,210 |
| Part B viscosity (cP at 10 1/second and 25° C.) | 2,350 | 2,350 | 2,350 | 2,350 | 2,350 | 2,350 |
| Injection pressure (pounds per square inch; | 30 | 30 | 30 | 30 | 30 | 30 |
| “psi”) | | | | | | |
| Injection time (seconds; “s”) | 20 | 20 | 20 | 20 | 20 | 20 |
| Injection mass (grams; “g”) | 13.11 | 11.78 | 9.63 | 7.95 | 6.86 | 8.33 |
| Maximum injected length in mold cavity | 187 | 166 | 139 | 117 | 102 | 123 |
| (millimeters; “mm”) | | | | | | |
| 5 s dispensed mass (g) | 3.937 | 3.561 | 2.995 | 2.389 | 2.102 | 3.196 |

Part B was formulated to a constant viscosity of 2,350 cP, which is lesser than Part A.

It is shown by the teachings herein that increasing the amount of silica filler can increase the viscosity of Part A by 221% from 6,740 cP (1 wt. % silica filler) to 21,640 cP (3 wt. % silica filler), which is greater than a 3-fold increase that could be characterized as significant.

In general, it may be desirable that the viscosities of Part A and Part B are within about 50% to about 200% of each other. In this regard, better mixing through a static mixing element may be provided for.

It is shown that the weight of cured masses injected into the flow mold, in 20 seconds, decreases from 13.11 g to 6.86 g (a decrease of 47.7%), as the viscosity of Part A is increased. Exemplary Formula 1 nearly completely fills the flow mold (see FIG. 3), including the 1 mm depth step, with a length of 187 mm, while the length injected into the mold decreased to 102 mm (a length decrease of 45.5%) for Comparative Formula 5. In other words, the length of the cured masses decreased as the viscosity increased. Comparative Formula 5 was able to enter the 1 mm step region of the flow mold but only in the area very near to the center of the flow mold at the injection point.

The portion of the cured masses that filled the 1 mm step region is characterized by the straight edge portions that are differentiable from the curved ends of the cured masses.

Comparative Formula 5 is less suitable for injection relative to Exemplary Formula 1 and accordingly less preferred with its higher viscosity.

Regarding the samples freely dispensed upon the surface, without resistance against flow into the flow mold by the fixed volume thereof, the weight of the cured masses that were dispensed in 5 seconds decreases from 3.937 g to 2.102 g, respectively, for Formulas 1 to 5 (a decrease of 46.6%). Thus, the increase in viscosity from Formulas 1 to 5 causes an approximately comparable percentage of decrease in flow rate through the tortuous mixing nozzle as the decreases in length and mass injected into the mold.

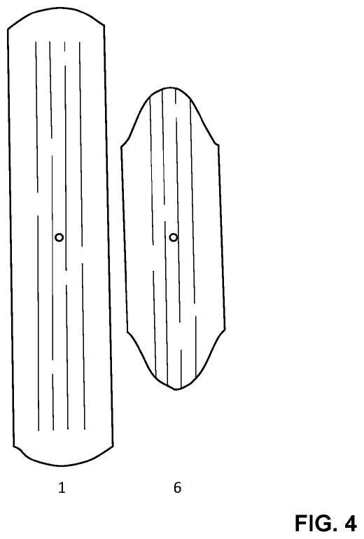

It is shown that changing from the bisphenol F epoxy resin (3,500 cP at 25° C.) to the approximately 3.5× higher viscosity bisphenol A liquid epoxy (12,500 cP at 25° C.), which is used in about a quarter of the weight, similarly affects injection/dispensing properties, as shown in FIG. 4. Table 2 also shows the decrease in weight of cured masses from 13.11 g to 8.33 g (a 36% decrease) and injected length from 187 mm to 123 mm (a 34% decrease). Dispensed freely onto the surface, the cured mass that was dispensed in 5 seconds decreased from 3.937 g to 3.196 g (an 18.8% decrease).

Exemplary Formula 1 provides a rapid gel time of about 1 min in a 3 mm diameter bead and lap shear values of 23.4 MPa on 1.5 mm cold rolled steel (12.5×25×0.25 mm bond volume), 14.3 MPa on 1.5 mm EG-60 (12.5×25 0.25 mm bond volume), 9.3 MPa on 1.5 mm 304 stainless steel (12.5×25×1 mm bond volume), and 9.7 MPa on 3 mm thick pultruded glass fiber composite (25×25×1 mm bond volume). Lap shear was prepared and tested based on ASTM D1002-10 at a rate of 10 mm/min.

Exemplary Formula 1 balances performance in high throughput manufacturing environments that require fast curing times, high adhesive strength (as characterized by said lap shear), and low viscosity to enable injection into narrow bond lines of at least about 1 mm and distances of about 90 mm or more away from the injection location. This rapid curing, dispensable/injectable adhesive provides many options in methods of assembly and part design in modern manufacturing environments (e.g., automotive manufacturing).

The foregoing indicates that the viscosity of selected resins, curing agents, and fillers must all be considered for dispensing properties. Utilizing excess fillers, or resins of greater viscosity, have negative effects on the injectability of the two-part adhesive.

The limits of injectability may be dependent on the geometry cross-section of the bond line, including the height, width, and length. For taller bond lines and shorter lengths of travel, there may be more leniency in the viscosities of the two-part adhesive. That is, Comparative Formula 5 may be acceptable for one application where only Exemplary Formula 1 may be acceptable in another.

By the present teachings, it is recommended that the viscosity of the injectable composition parts remain less than about 30,000 cP, more preferably less than about 20,000 cP, and even more preferably less than 10,000 cP at 25° C.

For Part A, beneficial formula ingredients include, but are not limited to, bisphenol F liquid epoxy resin (about 3,500 cP) and epoxidized vegetable oils such as castor oil and/or linseed oil (about 400-750 cP).

For Part B, the 85% phosphoric acid (30-50 cP) and phosphoric acid esters (about 3,000 cP here, but subject to vary by type) are also comparatively low in viscosity. The advantage of these significantly lower viscosity ingredients (particularly about 1,000 cP or less), is that they provide formulation flexibility and allow for the use of balanced quantities of viscosity increasing fillers or higher molecular weight resins or tougheners to increase adhesive bonding performance.

It is understood that the above description is intended to be illustrative and not restrictive. The explanations and illustrations presented herein are intended to acquaint others skilled in the art with the invention, its principles, and its practical application.

Those skilled in the art may adapt and apply the invention in its numerous forms, as may be best suited to the requirements of a particular use. Many embodiments as well as many applications besides the examples provided herein will be apparent to those of skill in the art upon reading the above description.

Accordingly, the specific embodiments of the invention set forth herein are not intended as being exhaustive or limiting of the teachings. The scope of the invention should, therefore, be determined not with reference to the above description, but should instead be determined with reference to the appended claims, along with the full scope of equivalents to which such claims are entitled.

The omission in the following claims of any aspect of subject matter that is disclosed herein is not a disclaimer of such subject matter, nor should it be regarded that the inventors did not consider such subject matter to be part of the disclosed inventive subject matter.

The disclosures of all articles and references, including patent applications and publications, are incorporated by reference for all purposes.

Plural elements or steps can be provided by a single integrated element or step. Alternatively, a single element or step might be divided into separate plural elements or steps.

The disclosure of “a” or “one” to describe an element or step is not intended to foreclose additional elements or steps.

The use of “about” or “approximately” in connection with a range applies to both ends of the range. Thus, “about 20 to 30” is intended to cover “about 20 to about 30”, inclusive of at least the specified endpoints.

Unless otherwise stated, all ranges include both endpoints and all numbers between the endpoints in increments of one unit provided that there is a separation of at least 2 units between any lower endpoint and any higher endpoint. As an example, if it is stated that the amount of a component, a property, or a value of a process variable such as, e.g., temperature, pressure, time, and the like is, e.g., from 1 to 90, from 20 to 80, or from 30 to 70, it is intended that intermediate range values such as, e.g., 15 to 85, 22 to 68, 43 to 51, 30 to 32, etc., are within the teachings of this specification. Likewise, individual intermediate values are also within the present teachings.

For values which are less than one, one unit is considered to be 0.0001, 0.001, 0.01, or 0.1 as appropriate. These are only examples of what is specifically intended and all possible combinations of numerical values between the lowest endpoint and the highest endpoint enumerated are to be considered to be expressly stated in this application in a similar manner.

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

While the terms first, second, third, etc., may be used herein to describe various elements, components, regions, layers, and/or sections, these elements, components, regions, layers, and/or sections should not be limited by these terms. These terms may be used to distinguish one element, component, region, layer, and/or section from another region, layer, and/or section. Terms such as “first,” “second,” and other numerical terms when used herein do not imply a sequence or order unless clearly indicated by the context. Thus, a first element, component, region, layer, and/or section discussed below could be termed a second element, component, region, layer, and/or section without departing from the teachings.

As used herein, the terms “comprising” and “including” may be used interchangeably. This preferably applies with respect to the appended claims.

As used herein, “aliphatic” preferably means a straight or branched hydrocarbon radical containing up to twenty four carbon atoms wherein the saturation between any two carbon atoms is a single, double, or triple bond. An aliphatic group preferably contains from about 1 to about 24 carbon atoms, more typically from about 1 to about 12 carbon atoms with from about 1 to about 6 carbon atoms being more preferred.

As used herein, “cycloaliphatic” preferably means a saturated or unsaturated, non-aromatic hydrocarbon moiety having from 1 to 3 rings, each ring having from 3 to 8 (preferably from 3 to 6) carbon atoms.

As used herein, “aromatic” preferably means a mono- or polycyclic carbocyclic ring system radicals having one or more aromatic rings. Examples of aryl groups include, without limitation, phenyl and naphthyl.

The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

As can be seen, the teaching of amounts expressed as “parts by weight” herein also contemplates the same ranges expressed in terms of percent by weight. Thus, an expression in the of a range in terms of “at least ‘λ’ parts by weight of the resulting composition” also contemplates a teaching of ranges of same recited amount of “x” in percent by weight of the resulting composition.”

### REFERENCE NUMERALS

10 Flow mold
12 Cavity
14 Step
16 Holes
18 Injection port

What is claimed is:

1. A two-part composition, for forming an adhesive, comprising:
a first part including one or more epoxy resins and/or epoxy-functionalized resins; and
a second part including one or more acidic phosphorous-containing compounds including mineral acid and/or one or more acidic phosphate esters;
preferably wherein the first and second parts each have a viscosity of about 30,000 cP or less at 25° C. and a shear rate of about 10 l/second, as measured by ASTM D2556-14, such that, after mixing of the first and second parts, a mixture is formed that is injectable into a bond line defined by a dimension between two surfaces to be adhered by the mixture.

2. The two-part composition according to claim 1, wherein the viscosity of the first and/or second parts is about 20,000 cP or less at 25° C.

3. The two-part composition according to claim 2, wherein the two-part composition is dispensed at a volumetric ratio of about 5:1 to 1:5 of the first part to the second part.

4. The two-part composition according to claim 1, wherein the dimension of the bond line is about 2 mm or less; and wherein the mixture migrates from an injection port, within the dimension of the bond line, a distance of about 50 mm to 100 mm; and wherein the distance is realized by injection of the two-part composition at ambient temperature and a pressure of about 30 psi, and during a period of about 20 seconds.

5. (canceled)

6. The two-part composition according to claim 4, wherein the mixture cures to form a solid cured mass within the bond line, the solid cured mass having a weight of about 8 g to 14 g; and wherein the weight is realized by injection of the two-part composition at ambient temperature and a pressure of about 30 psi, and during a period of about 20 seconds.

7. The two-part composition according to claim 1, wherein the mixture cures at about 50° C. or less; and wherein the mixture cures in about 10 minutes or less.

8. (canceled)

9. The two-part composition according to claim 1, wherein the one or more acidic phosphate esters include a phosphate ester derived from a natural oil, preferably a plant-origin oil that includes at least one phenolic compound with an aliphatic side chain.

10. The two-part composition according to claim 1, wherein the one or more acidic phosphate esters include a phosphate ester derived from 2-ethylhexyl glycidyl ether.

11. The two-part composition according to claim 1, wherein the one or more acidic phosphate esters include a phosphate ester derived from phenyl glycidyl ether.

12. The two-part composition according to claim 1, wherein the one or more acidic phosphate esters include a phosphate ester derived from 1-butanol.

13. The two-part composition according to claim 1, wherein the one or more epoxy resins and/or epoxy-functionalized resins include one or more liquid epoxy resins, one or more epoxy phenol novolac resins, one or more aliphatic multifunctional resins, one or more epoxy functional natural oils, one or more silane modified epoxy resins, or any combination thereof.

14. The two-part composition according to claim 13, wherein the one or more liquid epoxy resins include a reaction product of bisphenol A and epichlorohydrin, a reaction product of bisphenol F and epichlorohydrin, or both.

15. The two-part composition according to claim 13, wherein the one or more aliphatic multifunctional resins include epoxidized sorbitol.

16. The two-part composition according to claim 13, wherein the one or more epoxy functional natural oils are derived from linseed oil and/or castor oil.

17. The two-part composition according to claim 1, further comprising a metal carbonate in the first part, which generates gas after mixing with the second part by a reaction with the one or more acidic phosphorous-containing compounds; wherein the metal carbonate includes calcium carbonate; and wherein the calcium carbonate is present in an amount of about 3% or less, by weight of the first part.

18. The two-part composition according to claim 1, wherein the one or more epoxy resins and/or epoxy-functionalized resins have a viscosity, at 25° C., of about 4,000 cP or less.

19. The two-part composition according to claim 18, wherein the one or more epoxy resins and/or epoxy-functionalized resins include: a reaction product of bisphenol F and epichlorohydrin, and one or more epoxy functional natural oils.

20. The two-part composition according to claim 1, wherein the first part further comprises a filler in an amount of about 3% or less, by weight of the first part; and wherein the filler includes silica.

21. The two-part composition according to claim 1, wherein the second part is a blend of the mineral acid and the one or more acidic phosphate esters.

22. The two-part composition according to claim 7, wherein the first and second parts are each selected so that a rate of cure, upon being mixed, is sufficiently low that the bond line can be filled but is sufficiently high so that a resulting adhered bond line is cured within a period of no greater than 10 minutes.

23. (canceled)

24. (canceled)

25. (canceled)

26. (canceled)
